(19) United States
(12) Patent Application Publication
(10) Pub. No.: US 2025/0222479 A1
(43) Pub. Date: Jul. 10, 2025

(54) SIMULATION METHOD FOR A COATING INSTALLATION, AND CORRESPONDING COATING INSTALLATION

(71) Applicant: Dürr Systems AG, Bietigheim-Bissingen (DE)

(72) Inventors: Hans-Jürgen Nolte, Besigheim (DE); Christoph Heckeler, Renningen (DE); Tjark Bringewat, Stuttgar (DE)

(21) Appl. No.: 18/854,044

(22) PCT Filed: Apr. 3, 2023
(86) PCT No.: PCT/EP2023/058669

§ 371 Date: Oct. 3, 2024

(30) Foreign Application Priority Data
Apr. 4, 2022 (DE) 10 2022 108 004.8

(51) Int. Cl. B05B 12/08; B05B 12/12; B05B 13/04; G05B 19/4069

(52) U.S. Cl. CPC B05B 12/084; B05B 12/122; B05B 13/0431; G05B 19/4069; G05B 2219/49056

(57) ABSTRACT

A simulation method for a coating installation including:
a) specification of geometric data of the component to be coated,
b) specification of general coating parameters,
c) specification of starting values of coating parameters to be adjusted, including a coating path and current spray patterns for the individual path points of the coating path, whereby the current spray patterns represent the coating thickness distribution on the component,
d) program-controlled execution of a simulation loop, including:
   calculation of a simulated coating result by computational superimposition of the current spray patterns provided for the individual path points of the coating path, taking into account the degree of wetness,
   testing the simulated coating result, taking into account the degree of wetness,
   adjusting the coating parameters to be optimized and repeat the simulation loop if the simulated coating result is not satisfactory,.
   terminating the simulation loop if the simulated coating result is satisfactory.

### CROSS-REFERENCE TO RELATED APPLICATIONS

This application is a national stage of, and claims priority to, Patent Cooperation Treaty Application No. PCT/EP2023/058669, filed on Apr. 3, 2023, which application claims priority to German Application No. DE 10 2022 108 004.8, filed on Apr. 4, 2022, which applications are hereby incorporated herein by reference in their entireties.

### FIELD

The disclosure relates to a simulation method for a coating installation for coating a component by means of an applicator, in particular for a painting installation for painting motor vehicle body components with an atomizer or a print head. The disclosure also relates to a corresponding coating installation for carrying out the simulation method.

### BACKGROUND

DE 10 2019 113 341 A1 and DE 10 2020 114 201 A1 disclose a simulation method that makes it possible to simulate painting processes.

In this process, geometry data is initially specified that reflects the geometry of the component to be painted. For example, this geometry data can be specified in the form of a CAD file (CAD: Computer Aided Design), whereby the CAD file represents the shape of a vehicle body to be painted.

Furthermore, general painting parameters are specified, such as the air temperature in the paint booth or paint parameters (e.g. viscosity of the paint).

In addition, a painting path is specified that is to be followed by the paint impact point of the application device used (e.g. rotary atomizer) during operation.

Furthermore, starting values of the painting parameters to be optimized are defined, which can be so-called current spray patterns, i.e. layer thickness distributions around the respective paint impact point. These current spray patterns are then superimposed as part of the simulation.

Within the scope of the disclosure, this computational superimposition of the current spray patterns can also be carried out using a projection method, i.e. the spray patterns (possibly adapted with regard to certain aspects of the coating situation) are geometrically projected onto the workpiece geometry. The current spray patterns projected onto the workpiece geometry are then superimposed. The term used in the context of the disclosure for superimposing the current spray patterns therefore also includes the projection method mentioned above.

The current spray patterns can then be optimized in a simulation loop in order to achieve the best possible painting result in the simulation. For example, one optimization goal can be to achieve a coating thickness that is as uniform as possible.

The current spray patterns used in the simulation of the coating process can be derived from reference spray patterns that are stored in a database for various reference coating situations. As part of the simulation loop, the current coating situation is first determined for each path point of the coating path. A reference spray pattern is then read from the database, which was measured in a reference painting situation that corresponds as closely as possible to the actual current painting situation. In some examples, however, the database may not contain corresponding reference spray patterns for all possible current painting situations. In practice, it is therefore intended that the current spray pattern is determined by interpolation or by mathematical adaptation of reference spray patterns stored in the database.

The known simulation method described above provides satisfactory simulation results. However, there is a need for further optimization of this known simulation method.

### BRIEF DESCRIPTION OF THE DRAWINGS

FIGS. 1A and 1B show a flow chart to illustrate the simulation process according to the disclosed technology.

FIG. 2A shows a schematic representation of the superposition of three current spray patterns, which are applied to three parallel coating paths.

FIG. 2B shows the resulting layer thickness of the superposition of the three current spray patterns.

FIG. 2C shows the number of overlays of the current spray patterns at different points on the component surface.

FIG. 2D shows the progression of the degree of wetness for different points on the component surface.

FIG. 3A shows a coating with three overlays of current spray patterns that contribute very differently to the overall coating thickness.

FIG. 3B shows a modification of FIG. 3A, whereby the individual overlays contribute evenly to the overall coating thickness.

FIG. 4A shows a reference spray pattern that was measured in a reference coating situation.

FIG. 4B shows a corresponding current spray pattern in a modified current coating situation, whereby the current spray pattern was derived from the reference spray pattern according to FIG. 4A.

FIG. 5 shows a simplified schematic representation of a painting installation according to the disclosure with a simulation computer for carrying out the simulation process according to the disclosure.

### DETAILED DESCRIPTION

The disclosed technology is based on the task of creating a correspondingly improved simulation process.

Furthermore, the disclosure is based on the task of creating a correspondingly adapted coating installation which is suitable for carrying out the simulation process according to the disclosure. This task is solved by a simulation method and by a coating installation according to the claims.

The disclosure is based on the newly gained technical-physical knowledge that the quality of the coating does not only depend on the uniformity of the coating thickness. Rather, the quality of the coating is also determined by the so-called degree of wetness. In the simulation, several current spray patterns are superimposed, so that the coating in the simulation consists of several superimposed current spray patterns. Similarly, the real coating on the real component also has several overlays that originate from several spray patterns that were applied to the component surface along parallel coating paths, for example.

It is possible for the various overlays of current spray patterns to each contribute equally to the overall layer thickness. If, for example, three current spray patterns are superimposed at one point on the component surface, each current spray pattern can contribute one third to the overall coating thickness. However, it is also possible that the various overlays of current spray patterns contribute very differently to the overall layer thickness. With three overlays, for example, it is possible that the individual overlays contribute in the ratio 70%: 20%: 10% to the total layer thickness. In the context of the disclosure, the degree of wetness can then reflect the percentage of the total coating thickness that the individual overlaid layers contribute. For example, the degree of wetness can indicate what the largest percentage share of one of the overlays in the total coating thickness is.

In addition, the number of overlays of different layers can also vary within the coated component surface. For example, the coating at one location on the component surface may comprise three superimposed layers of current spray patterns, while the coating at another location on the component surface may comprise five superimposed layers of current spray patterns. The term “degree of wetness” used in the context of the disclosure can then also indicate how many superimposed layers of current spray patterns the coating comprises at the respective point on the component surface.

Furthermore, the degree of wetness can also reflect the geometric properties of the current spray patterns, which have an influence on the overall layer thickness at the respective point on the component surface.

Furthermore, within the scope of the disclosure, it is also possible for the degree of wetness to indicate how high the total layer thickness is at the respective point on the component surface. The term “degree of wetness” used in the context of the disclosure may reflect one or more of the above definitions.

When determining the degree of wetness, several or all locally involved spray patterns can be taken into account within the scope of the disclosure (e.g. mean value of the proportions, ratio of the proportions, . . . ) or only one specific locally involved spray pattern (e.g. the one that leads to the highest degree of wetness at the location under consideration, the one that is the last to be overcoated, . . . ).

It should be mentioned here that different current spray patterns can be used when calculating the simulated coating result than when calculating the degree of wetness.

The simulation method according to the disclosure is preferably suitable for a painting installation for painting motor vehicle body components using an atomizer (e.g. rotary atomizer) or a print head. However, the disclosure is not limited to use in a painting installation, but can also be realized in connection with a coating installation that applies other coating agents, such as adhesive, insulating material or sealant, to name just a few examples.

Furthermore, the disclosure is also not limited for use in a painting installation that paints vehicle body components. With regard to the components to be coated, the disclosure is therefore not limited to motor vehicle body components.

Furthermore, the disclosure is not only suitable for simulations in coating installations that use an atomizer (e.g. rotary atomizer) or a print head as applicator. The principle according to the disclosure is also generally applicable in this respect.

The simulation method according to the disclosure initially provides that geometry data are specified which reflect the geometry of the component to be coated. For example, these geometry data can be read from a component file in the form of CAD data (CAD: Computer Aided Design) of the component to be coated. Alternatively, it is also possible to generate the geometry data of the component to be coated by measuring a real component.

Furthermore, the simulation method according to the disclosure also provides, in accordance with the known simulation method described at the beginning, that general coating parameters are initially specified, such as coating agent parameters (e.g. viscosity), applicator type, bell cup type or path spacing of the adjacent coating paths. These general coating parameters are preferably specified by the user or read out from a data memory. It should be mentioned here that these general coating parameters do not have to be optimized as part of the simulation process according to the disclosure. However, it is also possible within the scope of the disclosure for the general coating parameters to be optimized as well.

In addition, starting values for coating parameters to be optimized are then defined. The coating parameters to be optimized initially comprise a coating path, which consists of numerous path points and is to be followed by the paint impact point of the applicator (e.g. rotary atomizer) in coating operation, as is known per se from the prior art. It should be noted here that the term “path point” is to be understood generally in the context of the disclosure and preferably refers to the temporal or spatial discretization of the path trajectory (e.g. one path point every x milliseconds or one path point every y millimeters).

In addition, the coating parameters to be optimized also include so-called current spray patterns for the individual path points of the coating path, whereby the current spray patterns reflect the coating thickness distribution on the component around the paint impact point on the component.

It should be mentioned here that the starting values of the coating parameters to be optimized do not have to be specified by the user, but can be defined by the program. For example, the starting values of the current spray patterns can be derived from reference spray patterns that were previously determined for various coating situations, for example by coating test sheets, as is known from the prior art.

The simulation method according to the disclosure then provides for the program-controlled execution of several steps in a simulation loop, whereby the individual steps are carried out for the individual path points of the coating path.

First, a simulated coating result is calculated as part of the simulation loop by superimposing the actual current spray patterns for the individual points of the coating path. This superimposition of the current spray patterns can also be carried out using a projection method, for example, as described in detail below.

In the simulation loop, the simulation result is then checked in a next step, whereby, for example, the uniformity of the resulting layer thickness is evaluated as a quality parameter. However, the degree of wetness in the individual points of the component surface is determined and taken into account as a quality parameter.

The next step in the simulation loop is to adjust the coating parameters to be optimized (e.g. current spray patterns, coating path) in order to optimize the simulated coating result.

The simulation loop is then repeated until the simulated coating result is satisfactory and the degree of wetness in the individual points of the component surface determined during the simulation is also acceptable.

The procedure explained above is described again below in other words in order to avoid misunderstandings. The user can assign different (or the same) reference spray patterns to different path sections. With regard to the first simulation run, these would be the starting values specified by the user (e.g. in a brush table with spray pattern width and scaling factor for the spray pattern height). Depending on the painting situation on the workpiece, these reference spray patterns can be automatically adapted by the program to create current spray patterns, which are then used for the simulation. With regard to the first simulation run, these would be the starting values that are automatically determined by the program based on the reference spray patterns specified by the user and the painting situation on the workpiece. If the first simulation result is not satisfactory, the user changes the assignment of reference spray patterns (e.g. wider spray pattern, higher spray pattern, . . . ), i.e. he changes the start values from the first simulation run. Consequently, the automatically defined current spray patterns used for the simulation also change. This continues until a satisfactory coating thickness result is achieved.

It has already been mentioned above that the coating parameters to be optimized (e.g. current spray patterns, coating path) are optimized as part of the simulation loop. This optimization can, for example, be performed by an operator based on experience. In some embodiments, however, the coating parameters to be optimized can be adjusted in the simulation loop using artificial intelligence (AI).

At the start of the simulation loop, starting values for the current spray patterns in the individual points of the coating path are specified. When determining the current spray patterns, the respective current coating situation can be taken into account. For example, the current coating situation is characterized by the coating distance (i.e. the distance between the applicator and the component surface), the component geometry at the paint impact point and similar coating parameters. Depending on this current coating situation in the individual path points of the coating path, the associated current spray patterns can then be determined with the aid of a spray pattern database in which reference spray patterns for different coating situations are stored.

For example, the stored reference spray patterns can be determined in spray pattern tests in which test sheets are coated in different reference coating situations. The coating thickness distribution on the test sheets is then measured and stored in the spray pattern database with the associated coating parameters that define the respective reference coating situation. The current spray patterns can then be derived from the stored reference spray patterns, which can also be done, for example, by interpolating various stored reference spray patterns. If, for example, the current coating situation does not correspond exactly to the reference coating situation of the reference spray patterns stored in the spray pattern database, two or more reference spray patterns can be interpolated that were determined for similar coating situations.

However, the current spray patterns do not necessarily have to be determined from the stored reference spray patterns by interpolation from several stored reference spray patterns. Alternatively, it is also possible to determine a current spray pattern by mathematically adjusting a stored reference spray pattern. This adaptation of the reference spray patterns stored in the database according to the current coating situation can also be carried out by an algorithm, for example by means of artificial intelligence (AI).

In practice, the adjustment can be carried out automatically using correction or scaling factors if the current coating situation is a geometric edge (e.g. coating path on workpiece edge), as a certain percentage of the coating agent beams (projection beams) then pass by the workpiece. The adjusted spray pattern can then be projected onto the workpiece surface.

The current coating situation and the reference coating situation can, for example, be defined by at least one of the following variables:
Type of applicator,
type of a bell cup of a rotary atomizer forming the applicator,
type of a shaping air ring used on the applicator,
application parameters, in particular
   coating agent flow rate,
   air flow rate,
   speed of the bell cup,
   high voltage of an electrostatic coating agent charging system,
spatial orientation of an applicator axis of the applicator relative to the surface of the component to be coated,
absolute spatial direction of an applicator axis in space,
booth parameters of a coating booth, in particular
   booth temperature in the coating booth,
   downward-air speed in the coating booth,
path distance between adjacent coating paths,
path speed at which the applicator is moved along the coating path,
coating path used for measuring the reference spray pattern,
coating path in the current coating situation,
geometry of the test component used to measure the reference spray pattern,
geometry of the component to be coated.

It has already been mentioned above that the reference spray patterns stored in the spray pattern database can be determined by coating tests on test sheets before the simulation loop. The coating thickness distribution measured on the test sheets is then stored in the spray pattern database as a reference spray pattern in an assignment to the respective reference coating situation.

It should also be mentioned that the reference spray patterns stored in the spray pattern database can be either dynamic or static spray patterns. Dynamic spray patterns are measured as a result of coating processes in which the applicator moves relative to the component (e.g. test sheet). Static spray patterns, on the other hand, are measured as a result of coating processes in which the applicator is stationary relative to the component (e.g. test sheet).

In the simulation loop, it is then possible to continuously check at which points of the coating path the adjustment of the coating parameters to be optimized has led to a change in the coating parameters. This means that the coating parameters are not usually changed at all path points in the various runs of the simulation loop. The simulation then only needs to be updated in those path points in which the optimization of the coating parameters has actually led to a change. In the context of the disclosure, it is therefore not necessary for the simulation loop to extend over all path points of the coating path in each run.

Furthermore, it should be mentioned that the above-mentioned general coating parameters may comprise at least one of the following variables:
Coating agent properties of the coating agent, in particular viscosity of the coating agent,
type of applicator,
type of bell cup of a rotary atomizer,
booth parameters of a coating booth, in particular
   booth temperature in the coating booth,
   downward-air speed in the coating booth,
desired coating thickness of the coating agent on the component,
path distance between adjacent coating paths,
path speed at which the applicator is moved along the coating path.

The coating parameters to be optimized can, for example, include at least one of the following variables:
Spatial course of the coating path, in particular with coordinates of the individual path points,
spatial orientation of the applicator axis of the applicator in the individual points of the coating path,
brush parameters, in particular
   coating agent flow,
   shaping air flow,
   voltage of an electrostatic coating agent charging system,
switch-on points of the applicator on the coating path,
switch-off points of the applicator on the coating path,
coating agent flow in the individual points of the coating path,
atomizer speed in the individual path points of the coating path,
high voltage of an electrostatic coating agent charging system,
applicator type, especially for sealing applications,
path distance between adjacent coating paths,
path speed at which the applicator is moved along the coating path,
the general coating parameters mentioned above.

In the context of the disclosure, the simulated coating result can then be displayed graphically on a screen to enable an operator to make a simple assessment. However, it is also possible for the simulated coating result to be evaluated automatically, for example by artificial intelligence (AI).

After completion of the simulation process according to the disclosure, optimized coating parameters are then available for the individual path points of the coating path. These optimized coating parameters can then be transferred to a control system of the coating installation so that the control system then controls the coating installation accordingly in real coating operation. In practice, the optimized coating parameters are thus converted into real control variables for controlling the coating installation.

This conversion (“forward translation”) of the optimized coating parameters into real control variables for controlling the coating installation can relate to the commissioning or optimization of existing systems or existing coatings. However, within the scope of the disclosure, it is also possible for existing control variables of the coating installation to be read in by the simulation computer and converted into start parameterizations for the simulation. Control variables for the control of the coating installation that have already been tested in real life are used here as starting values for coating parameters to be optimized (“backward translation”). The term “conversion of the optimized coating parameters into real control variables for controlling the coating installation” used in the context of the disclosure is therefore to be understood in general terms.

Furthermore, it should be mentioned that the disclosure does not only claim protection for the simulation method according to the disclosure described above. Rather, the disclosure also claims protection for a corresponding coating installation which is suitable for carrying out the simulation method according to the disclosure. In addition to at least one coating robot with an applicator (e.g. rotary atomizer) and a control system, the coating installation according to the disclosure also has a simulation computer on which a simulation program is stored, which executes the simulation method according to the disclosure when it is carried out.

In general, the simulation can also be carried out on an “offline” computer (e.g. office laptop) (e.g. planning department, offline department, training department, . . . ), and the coating parameters found can then be transferred to the control system later/if required, for example.

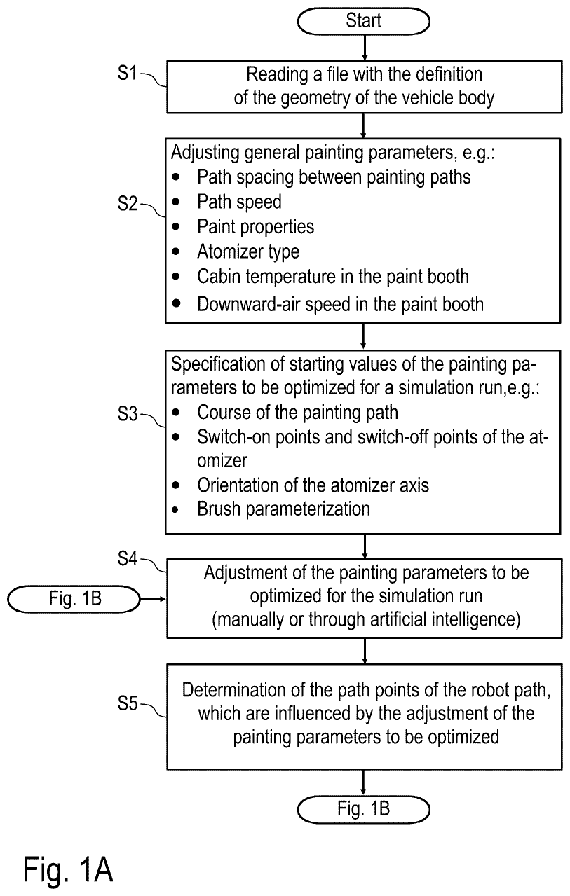

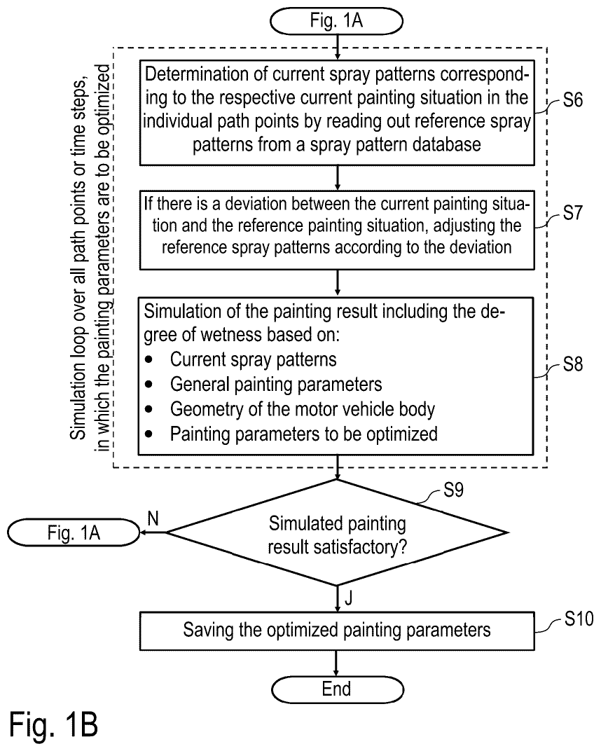

The flow chart shown in FIGS. 1A and 1B, which shows the simulation method according to the disclosed technology in simplified form, is described below.

In a first step S1, a file containing a definition of the geometry of the motor vehicle body to be painted is first read in. For example, this file can be provided by the manufacturer of the respective motor vehicle as a CAD file.

In a further step S2, general painting parameters are then set, such as the following painting parameters:
Path distance of the coating path,
path speed,
coating properties of the coating used,
atomizer type,
booth temperature in the spray booth,
Downward-air speed in the spray booth.

In a further step S3, starting values of the painting parameters to be adjusted or optimized are then specified under program control for a subsequent simulation run. For example, the painting parameters to be optimized can be the following painting parameters:
Course of the painting path,
switch-on points and switch-off points of the atomizer along the painting path,
orientation of the atomizer axis at the various points along the painting path,
brush parameterization, e.g. paint flow rate, shaping air flow, voltage of the high-voltage electrostatic charging system.

After the first run of the simulation loop, the painting parameters to be optimized for the next simulation run are then adjusted in step S4. This adjustment can be made, for example, based on experience by an operator or by artificial intelligence (AI).

In the next step S5, those path points of the robot path are then determined where the adjustment of the painting parameters to be optimized has led to a significant change in the painting situation. This is useful so that the simulation loop described in detail below does not have to include all path points of the robot path, including those path points in which the adjustment of the painting parameters to be optimized does not lead to a significant change.

In the following steps S6, S7 and S8, a simulation loop is then run through, which extends over all path points of the coating path in which the coating parameters have been significantly changed.

The first step S6 provides for current spray patterns to be determined according to the respective current painting situation in the individual path points. For example, reference spray patterns can be read from a spray pattern database for this purpose. These reference spray patterns can, for example, be determined beforehand by coating test sheets. When determining the current spray patterns corresponding to the respective current painting situation, a check is then first made to see whether a reference spray pattern is stored in the spray pattern database that was measured in a reference painting situation that corresponds exactly to the current painting situation. If this is the case, the stored reference spray pattern can be read out and accepted as the current spray pattern.

In some examples, however, this may not be possible. Instead, in practice, the current spray pattern is derived by calculation from one or more stored reference spray patterns that have been measured in similar reference coating situations. This adaptation of the stored reference spray patterns to determine the current spray patterns to be used in accordance with step S7 can be carried out using artificial intelligence (AI), for example. For example, a projection method can also be used, as already mentioned.

In the next step S8, the painting result including the degree of wetness is simulated on the basis of the following variables:
Current spray patterns for the individual path points of the painting path,.
general painting parameters,
geometry of the vehicle body,.
painting parameters to be optimized.

The next step S9 then checks whether the simulated painting result is satisfactory. If this is not the case, the painting parameters to be optimized are adjusted again for the next simulation run in step S4.

Otherwise, the optimized painting parameters are saved in the next step S10 and can then be used to control the painting installation in real painting operation.

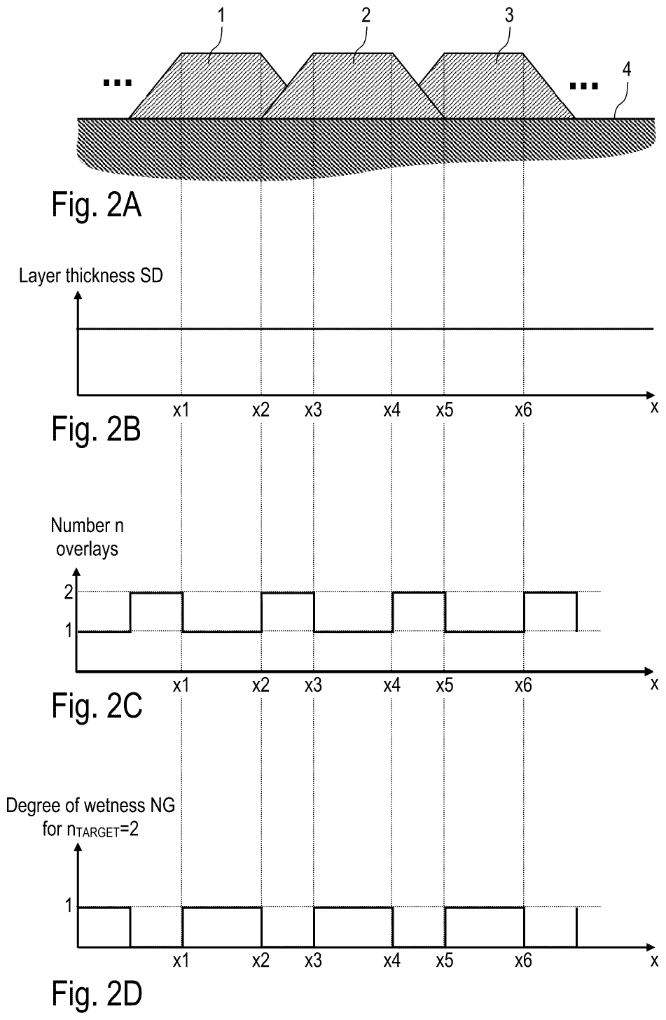

FIG. 2A shows an example of three current spray patterns 1, 2, 3, which are applied by a rotary atomizer when traversing three parallel sections of a coating path, with the current spray patterns 1-3 partially overlapping on a component surface 4. The current spray patterns 1-3 are shown in a simplified trapezoidal form. In practice, however, the current spray patterns 1-3 have a slightly different shape depending on the type of application device used. The schematic representation of the current spray patterns 1-3 therefore only serves to illustrate the disclosed technology.

FIG. 2B shows the resulting coating thickness SD for various points on the component surface at right angles to the path sections of the coating path. It can be seen from this illustration that the layer thickness SD is completely constant with an optimum superposition of the neighboring current spray patterns 1-3, which is an optimum state that cannot be achieved in practice.

FIG. 2C also shows that the current spray patterns 1-3 result in a coating composed of a different number of overlays due to their superposition. For example, the coating between x=x2 and x=x3 includes n=2 overlays, while the coating between x=x3 and x=x4 includes a single overlay (n=1). It should be noted that this example is merely theoretical and is intended to illustrate the disclosed technology.

Finally, FIG. 2D shows the progression of a possible degree of wetness NG along the component surface transverse to the path sections of the coating paths. It is assumed here that the desired number of overlays n_{TARGET}=2, i.e. the coating should include n=2 overlays of the current spray patterns 1-3 at each point of the component surface if possible. The degree of wetness NG is then defined at each point of the component surface as a deviation from this target value. Thus, the coating between x=x3 and x=x4 includes only the current spray pattern 2, so that the deviation from the desired number n_{TARGET}=2 of overlays is NG=1. Between x=x2 and x=x3, however, the coating includes the superposition of the two current spray patterns 1, 2, so that the degree of wetness NG as a deviation from the desired value is NG=0.

In the illustration according to FIGS. 2A-2D, the degree of wetness NG only indicates how many superimposed layers of the current spray patterns 1-3 the coating include at the respective point on the component surface.

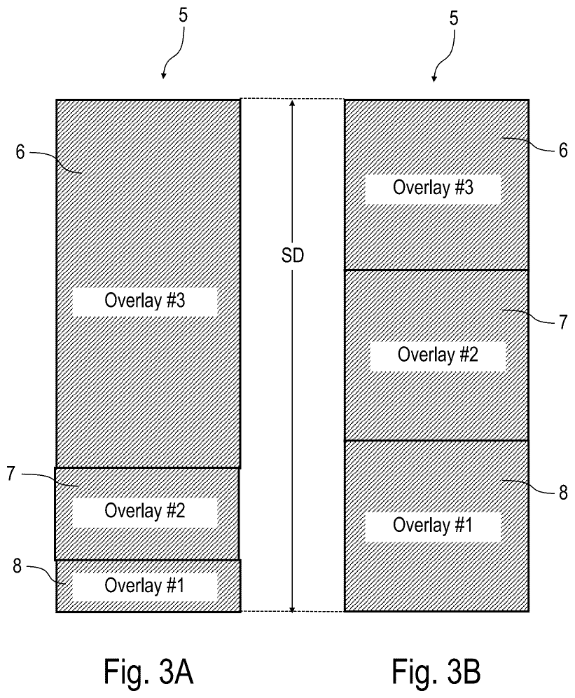

However, the degree of wetness can also indicate what percentage of the total coating thickness the individual layers of the current spray patterns account for. FIGS. 3A and 3B show a coating 5 with a total layer thickness SD, whereby the coating 5 is made up of three overlays 6-8 of current spray patterns. In FIG. 3A, the overlay 6 makes up a large part of the total layer thickness SD, which leads to a correspondingly greater degree of wetness. In FIG. 3B, on the other hand, the overlays 6-8 each contribute an equal third of the total layer thickness SD, which results in a correspondingly lower degree of wetness.

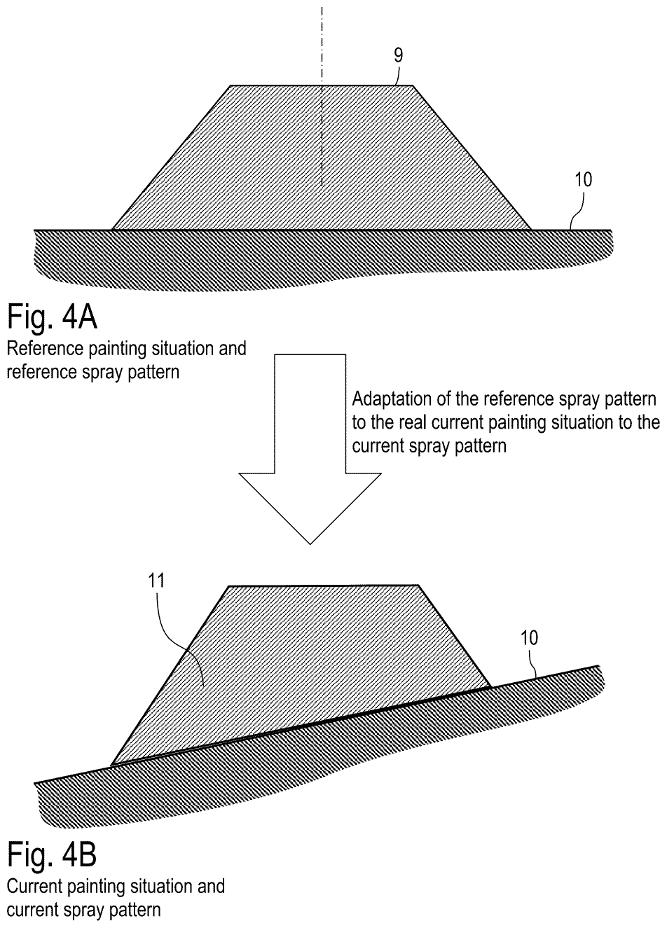

FIG. 4A schematically shows a reference spray pattern 9 on a component surface 10, whereby the reference spray pattern 9 was applied and measured in a reference painting situation. The reference painting situation was characterized, among other things, by the fact that the applicator axis was aligned at right angles to the component surface 10.

FIG. 4B, on the other hand, shows a current painting situation in which the applicator axis is aligned at an angle to the component surface 10. The deviation between the reference painting situation according to FIG. 4A and the current painting situation according to FIG. 4B leads to a correspondingly adapted current spray pattern 11. This adaptation of the stored reference spray pattern 9 to determine the current spray pattern 11 suitable for the simulation can be carried out using artificial intelligence (AI), for example. For example, a correction method or a projection method can also be used, as already mentioned.

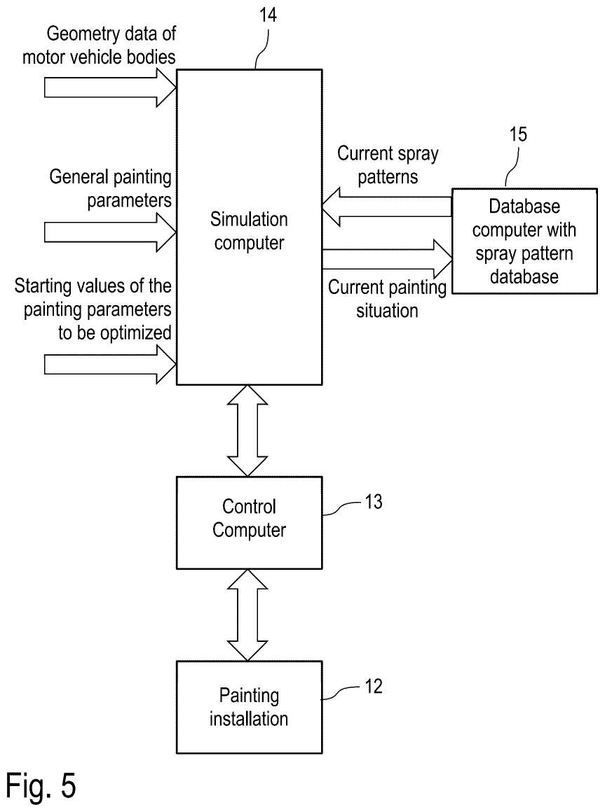

The schematic diagram shown in FIG. 5 is described below. First of all, the illustration shows a conventional painting installation 12 in a simplified form, which is controlled by a control computer 13.

In addition, a simulation computer 14 is shown, which is used to carry out the simulation method according to the disclosure. For this purpose, the simulation computer 14 is connected to a database computer 15, which contains a spray pattern database with stored reference spray patterns.

On the input side, the simulation computer 14 first receives the geometric data of the vehicle bodies to be painted.

In addition, the simulation computer 14 also receives general painting parameters on the input side.

Furthermore, the simulation computer 14 receives starting values of the painting parameters to be optimized on the input side. These starting values can include, for example, the painting path and current spray patterns for the individual points of the painting path.

The simulation computer 14 then transmits the respective current painting situation to the database computer 15, which determines a suitable current spray pattern corresponding to the respective current painting situation, usually by adapting or interpolating stored reference spray patterns. The database computer 15 then supplies a suitable current spray pattern to the simulation computer 14 for the individual path points of the painting path. The simulation computer 14 can then, together with the database computer 15, carry out the simulation process shown in FIGS. 1A and 1B in this way.

1.-14. (canceled)

15. A simulation method for a coating installation for coating a component by an applicator, the method comprising:
a) specification of geometry data which reproduces geometry of the component to be coated,
b) specification of general coating parameters,
c) specification of starting values of coating parameters to be adjusted, including:
c1) a coating path, including numerous path points, to be traversed by the applicator during a coating operation, and
c2) current spray patterns for individual path points of the coating path, wherein the current spray patterns produce a coating thickness distribution on the component around a coating agent impact point on the component, wherein the starting values of the current spray patterns are derived in a program-controlled manner from reference spray patterns which have been determined for different reference coating situations,
d) program-controlled execution of a simulation loop for the individual path points of the coating path, including:
d1) calculation of a simulated coating result by computational superimposition of the current spray patterns provided for the individual path points of the coating path,
d2) checking the simulated coating result,
d3) adjusting the coating parameters to be adjusted and repeating the simulation loop if the simulated coating result is not satisfactory,
d4) ending the simulation loop if the simulated coating result is satisfactory and adopting the adjusted coating parameters,
e) wherein during the calculation of the simulated coating result in the simulation loop, a degree of wetness of the simulated coating on the component is calculated for various points of the component surface, the degree of wetness representing at least one of the following information:
e1) how many superimposed layers of current spray patterns the coating includes at a respective point of the component surface,
e2) what percentage of the total layer thickness of the coating the individual superimposed layers of current spray patterns have at the respective point of the component surface,
e3) which geometric properties the current spray patterns have, which have an influence on the total layer thickness at the respective point of the component surface,
e4) how high the total layer thickness is at the respective point of the component surface.

16. The simulation method according to claim 15, wherein the geometry data are specified by reading out the geometry data of the component to be coated from a component file.

17. The simulation method according to claim 15, wherein the geometry data are specified by measuring the component to be coated and generating the geometry data when measuring the component to be coated.

18. The simulation method according to claim 15, wherein the adjustment of the coating parameters is carried out by an operator on the basis of experience.

19. The simulation method according to claim 15, wherein the adjustment of the coating parameters is carried out by using artificial intelligence.

20. The simulation method according to claim 15, further comprising determining the current spray patterns, which are used in the simulation loop in the individual path points of the coating path for simulating the coating result, including:
a) determining a current coating situation at the individual path points of the coating path, the current coating situation being defined by the geometry data, the coating parameters to be adjusted and the general coating parameters, and
b) determining the current spray patterns corresponding to the current coating situation.

21. The simulation method according to claim 20, wherein the current spray patterns are determined by reading out the current spray patterns for the individual path points as a function of the respective current coating situation from a spray pattern database in which reference spray patterns for various reference coating situations are stored.

22. The simulation method according to claim 20, wherein the current spray patterns are determined by calculating the current spray patterns according to the current coating situation from predetermined reference spray patterns which reproduce a reference coating situation.

23. The simulation method according to claim 20, wherein the determination of the current spray patterns to be used in the individual path points of the coating path, further comprises:
a) determining the current coating situation in the individual path points of the coating path,
b) determining the specified reference coating situation on which the reference spray pattern read from the spray pattern database is based,
c) comparison of the current coating situation with the reference coating situation and determination of a deviation between the current coating situation and the reference coating situation,
d) adapting the reference spray pattern read from the spray pattern database as a function of the deviation between the current coating situation and the reference coating situation.

24. The simulation method according to claim 23, wherein the adaptation of the reference spray pattern read out from the spray pattern database is carried out in accordance with the current coating situation by an algorithm.

25. The simulation method according to claim 23, wherein the reference spray pattern read out from the spray pattern database is adapted by correction or scaling factors if the geometry data of the current coating situation indicates a geometric edge.

26. The simulation method according to claim 20, wherein the current coating situation and the reference coating situation are defined by at least one of the following variables:
a) coating agent properties of the coating agent,
b) type of the applicator,
c) type of a bell cup of a rotary atomizer forming the applicator,
d) type of a shaping air ring used on the applicator,
e) application parameters, including:
e1) coating agent flow rate,
e2) shaping air flow rate,
e3) speed of the bell cup,
e4) high voltage of an electrostatic coating agent charging system,
f) spatial orientation of an applicator axis of the applicator relative to the surface of the component to be coated,
g) absolute spatial direction of an applicator axis in space,
h) booth parameters of a coating booth, including:
h1) booth temperature in the coating booth,
h2) downward-air speed in the coating booth,
i) path distance between adjacent coating paths,
j) path speed at which the applicator is moved along the coating path,
k) coating path used for measuring the reference spray pattern,
l) coating path in the current coating situation,
m) geometry of the test component used to measure the reference spray pattern,
n) geometry of the component to be coated.

27. The simulation method according to claim 20, wherein
a) the reference spray patterns stored in the spray pattern database are determined by coating tests prior to the simulation loop,
b) test sheets are coated in different coating situations during the coating tests,
c) a coating thickness distribution on the test sheets is measured during the coating tests, and
d) the coating thickness distribution measured on the test sheets is stored in the spray pattern database as a reference spray pattern in an assignment to the respective reference coating situation.

28. The simulation method according to claim 20, wherein the reference spray patterns stored in the spray pattern database are dynamic spray patterns which are measured as a result of coating processes in which the applicator moves relative to the component.

29. The simulation method according to claim 20, wherein the reference spray patterns stored in the spray pattern database are static spray patterns which are measured as a result of coating processes in which the applicator is stationary in relation to the component.

30. The simulation method according to claim 15, wherein execution of the simulation loop includes:
a) checking in which path points of the coating path the adaptation of the coating parameters to be adjusted has led to a change in the coating parameters, and
b) recalculating the simulated coating result completely or as a difference from the previously simulated coating result only in the region of those path points of the coating path in which the adjustment of the coating parameters to be adjusted has led to a change in the coating parameters.

31. The simulation method according to claim 15, wherein the general coating parameters comprise at least one of the following variables:
a) coating agent properties of the coating agent,
b) type of the applicator,
c) type of a bell cup of a rotary atomizer forming the applicator,
d) booth parameters of a coating booth, including:
d1) booth temperature in the coating booth,
d2) downward-air speed in the coating booth,
e) desired coating thickness of the coating agent on the component,
f) path distance between adjacent coating paths,
g) path speed at which the applicator is moved along the coating path.

32. The simulation method according to claim 15, wherein the coating parameters to be adjusted comprise at least one of the following variables:
a) spatial and/or temporal course of the coating path,
b) spatial orientation of an applicator axis of the applicator in the individual points of the coating path,
c) brush parameters, including coating agent flow,
d) switch-on points of the applicator on the coating path,
e) switch-off points of the applicator on the coating path,
f) coating material flow in the individual points of the coating path,
g) atomizer speed at the individual points of the coating path,
h) high voltage of an electrostatic coating agent charging system,
i) type of the applicator,
j) path distance between adjacent coating paths,
k) path speed at which the applicator is moved along the coating path,
l) the general coating parameters according to claim 31.

33. The simulation method according to claim 15, wherein checking the simulated coating result in the simulation loop further comprises:
graphically displaying the simulated coating result on a screen and evaluating it by an operator.

34. The simulation method according to claim 15, wherein checking the simulated coating result in the simulation loop further comprises:
automatic evaluation of the simulated coating result by use of artificial intelligence.

35. The simulation method according to claim 15, wherein
a) the simulated coating parameters are transmitted to a control system of the coating installation after the end of the simulation loop, and
b) the control system controls the coating installation in accordance with the transmitted coating parameters by converting the coating parameters into control variables for the coating installation.

36. A coating installation for coating components, comprising:
at least one coating robot,
at least one applicator which is guided by the coating robot,
a control system which controls the applicator and the coating robot, and
a simulation computer with a stored simulation program which, when executed, carries out a simulation method, comprising:
a) specification of geometry data which reproduces geometry of a component to be coated,
b) specification of general coating parameters,
c) specification of starting values of coating parameters to be adjusted, including:
c1) a coating path, including numerous path points, to be traversed by the applicator during a coating operation, and
c2) current spray patterns for individual path points of the coating path, wherein the current spray patterns produce a coating thickness distribution on the component around a coating agent impact point on the component, wherein the starting values of the current spray patterns are derived in a program-controlled manner from reference spray patterns which have been determined for different reference coating situations,
d) program-controlled execution of a simulation loop for the individual path points of the coating path, including:
d1) calculation of a simulated coating result by computational superimposition of the current spray patterns provided for the individual path points of the coating path,
d2) checking the simulated coating result,
d3) adjusting the coating parameters to be adjusted and repeating the simulation loop if the simulated coating result is not satisfactory,
d4) ending the simulation loop if the simulated coating result is satisfactory and adopting the adjusted coating parameters,
e) wherein during the calculation of the simulated coating result in the simulation loop, a degree of wetness of the simulated coating on the component is calculated for various points of the component surface, the degree of wetness representing at least one of the following information:
e1) how many superimposed layers of current spray patterns the coating includes at a respective point of the component surface,
e2) what percentage of the total layer thickness of the coating the individual superimposed layers of current spray patterns have at the respective point of the component surface,
e3) which geometric properties the current spray patterns have, which have an influence on the total layer thickness at the respective point of the component surface,
e4) how high the total layer thickness is at the respective point of the component surface.
